(19) United States
(12) Patent Application Publication
(10) Pub. No.: US 2026/0235810 A1
(43) Pub. Date: Aug. 13, 2026

(54) SPLITTER AND PHOTONIC INTEGRATED CIRCUIT INCLUDING THE SAME

(71) Applicant: SAMSUNG ELECTRONICS CO., LTD., Suwon-si (KR)

(72) Inventors: Hyunsung PARK, Suwon-si (KR); Jaekwan Kim, Suwon-si (KR); Subeom Song, Suwon-si (KR); Sungmo Ahn, Suwon-si (KR); Suyeon Lee, Suwon-si (KR); Junho Lee, Suwon-si (KR); Choonlae Cho, Suwon-si (KR); Sookyoung Roh, Suwon-si (KR); Sangeun Mun, Suwon-si (KR)

(73) Assignee: SAMSUNG ELECTRONICS CO., LTD., Suwon-si (KR)

(21) Appl. No.: 19/530,956

(22) Filed: Feb. 5, 2026

(30) Foreign Application Priority Data
Feb. 10, 2025 (KR) 10-2025-0016962

(51) Int. Cl. G02B 6/122; G02B 6/12

(52) U.S. Cl. CPC G02B 6/1228; G02B 6/1223; G02B 2006/12038; G02B 2006/1215

(57) ABSTRACT

Provided is a splitter including an input portion, an output portion, and a waveguide connected between the input portion and the output portion, wherein widths of adjacent portions in at least some regions of the waveguide change discontinuously, and wherein a deviation between the widths of the adjacent portions is less than a wavelength of input light in a vacuum.

### CROSS-REFERENCE TO RELATED APPLICATION

This application is based on and claims priority under 35 U.S.C. § 119 to Korean Patent Application No. 10-2025-0016962, filed on Feb. 10, 2025, in the Korean Intellectual Property Office, the disclosure of which is incorporated by reference herein in its entirety.

### BACKGROUND

### 1. Field

The present disclosure relates to a splitter and a photonic integrated circuit including the splitter.

### 2. Description of Related Art

In optical systems, a multi-mode interferometer (MMI) is widely used as a key component that distributes or combines light between multiple input and output channels. An MMI is generally designed to have a rectangular shape, and the amount of light transferred to each output channel may be adjusted by adjusting a length (a waveguide direction) and a width (a direction perpendicular to the waveguide direction) of the MMI. Accordingly, optical signals may be distributed according to the purpose.

The distribution characteristics of light to multiple channels may be controlled through the structural design of the MMI. Accordingly, light may be distributed based on a relatively simple structure, but when there are multiple output channels, it may be difficult to accurately control the distribution of light. Therefore, more accurately control of the distribution of light to the output channels may be needed.

### SUMMARY

The disclosure provides a splitter and a photonic integrated circuit including the splitter.

Additional aspects will be set forth in part in the description which follows and, in part, will be apparent from the description, or may be learned by practice of the presented embodiments of the disclosure.

According to an aspect of the disclosure, there is provided a splitter including an input portion, an output portion, and a waveguide connected between the input portion and the output portion, wherein widths of adjacent portions in at least some regions of the waveguide change discontinuously, and wherein a deviation between the widths of the adjacent portions is less than a wavelength of input light in a vacuum.

The input portion may include a plurality of input channels.

Wavelengths of light respectively incident on the plurality of input channels may be different from each other.

The output portion may include a plurality of output channels.

Wavelengths of light coupled to each other in each of the plurality of output channels may be different from each other.

Magnitudes of the light coupled to each other in each of the plurality of output channels may be different from each other.

The input portion may include one input channel, and the output portion may include a plurality of output channels.

The input portion may include a plurality of input channels, the output portion may include a plurality of output channels, and a number of the plurality of input channels may be different from a number of the plurality of output channels.

The input portion may include a plurality of input channels, the output portion may include a plurality of output channels, and a number of the plurality of input channels may be equal to a number of the plurality of output channels.

The input portion may have a tapered structure.

The output portion may have a tapered structure.

The splitter may further include an upper clad on a first portion of the waveguide, and a lower clad on a second portion of the waveguide opposite to the first portion of the waveguide.

The upper clad may include a material having a refractive index that is lower than a refractive index of the waveguide.

The upper clad may include silicon oxide.

The lower clad may include silicon oxide.

The waveguide may include one of silicon and silicon nitride.

A width of the waveguide may be constant in at least some regions of the waveguide.

According to an aspect of the disclosure, there is provided a photonic integrated circuit including a light source configured to emit light, a splitter configured to transmit the light from the light source, and a photodetector configured to convert the light transmitted from the splitter into electrical signals, wherein the splitter includes an input portion, an output portion, and a waveguide connected between the input portion and the output portion, the waveguide including an outer line, wherein widths of adjacent portions in at least some regions of the waveguide change discontinuously, and wherein a deviation between the widths of the adjacent portions is less than a wavelength of input light in a vacuum.

The input portion may include a plurality of input channels, and wavelengths of light incident on the plurality of input channels may be different from each other.

The output portion may include a plurality of output channels, and wavelengths of light coupled to each other in each of the plurality of output channels may be different from each other.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a view illustrating a splitter according to one or more embodiments;

FIG. 2 is a cross-sectional view illustrating an enlarged portion of the splitter in FIG. 1;

FIG. 3 is a cross-sectional view illustrating an enlarged portion of the splitter in FIG. 2;

FIG. 4 is a view illustrating a splitter according to one or more embodiments;

FIGS. 5A and 5B are views illustrating outer lines of a splitter according to one or more embodiments;

FIG. 6 is a view illustrating inputs and outputs of wavelengths for each channel of a splitter according to one or more embodiments;

FIG. 7A, FIG. 7B, FIG. 7C, FIG. 7D, FIG. 7E, FIG. 7F, FIG. 7G, and FIG. 7H are graphs illustrating inputs and outputs of wavelengths for each channel of a splitter according to one or more embodiments;

FIG. 8 is a view illustrating a splitter according to one or more other embodiments;

FIG. 9 is a view illustrating a splitter according to one or more other embodiments;

FIG. 10 is a view illustrating a splitter according to one or more other embodiments;

FIG. 11 is a view illustrating a splitter according to one or more other embodiments;

FIG. 12 is a view illustrating a splitter according to one or more other embodiments;

FIG. 13 is a view illustrating a splitter according to one or more other embodiments; and

FIG. 14 is a block diagram conceptually illustrating a configuration of a photonic integrated circuit according to one or more embodiments.

### DETAILED DESCRIPTION

Hereinafter, a splitter and a photonic integrated circuit including the splitter according to various embodiments are described in detail with reference to the attached drawings. In the following drawings, the same reference numerals refer to the same components, and a size of each component in the drawings may be exaggerated for the sake of clear and convenient description. Also, the following embodiments to be described are merely examples, and various modifications may be made from the embodiments.

Hereinafter, what is described as an “upper portion” or “on, over, or above” may also include not only “on” but also “above” and “over”. Singular expressions include plural expressions unless the context clearly indicates otherwise. In addition, when a portion “includes” a certain component, this means that other components may be further included rather than excluding other components unless specifically stated to the contrary.

Use of a term “the” and similar reference terms may correspond to both the singular and the plural. Steps constituting a method may be performed in any suitable order unless there is a clear statement that the steps should be performed in the order described or contrary to the order and are not limited thereto.

Connection or connection members of lines between configuration elements illustrated in the drawings exemplarily represent functional connections and/or physical or circuit connections and may be represented as alternative or additional various functional connections, physical connections, or circuit connections in an actual apparatus.

Use of all examples or all example terms is merely for describing technical ideas in detail, and the scope of claims is not limited by the examples or the example terms unless limited by the claims.

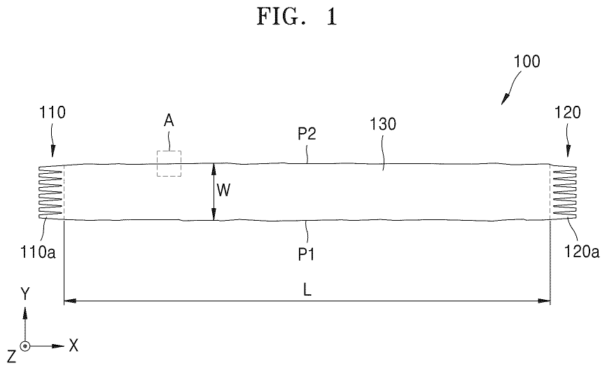

FIG. 1 is a view illustrating a splitter according to one or more embodiments. FIG. 1 is a cross-sectional view illustrating a xy plane of a splitter.

Referring to FIG. 1, a splitter 100 may include an input portion 110, an output portion 120, and a waveguide 130 connecting the input portion 110 to the output portion 120.

The input portion 110 may include a plurality of input channels 110a. Although FIG. 1 illustrates that the input portion 110 includes eight input channels 110a, embodiments are not limited thereto, and the input portion 110 may include the plurality of input channels 110a. Also, the input portion 110 may include one input channel 110a.

The output portion 120 may include a plurality of output channels 120a. Although FIG. 1 illustrates that the output portion 120 includes eight output channels 120a, embodiments are not limited thereto, and the output portion 120 may include the plurality of output channels 120a. Also, the output portion 120 may include one output channel 120a.

An optical signal may be input to the splitter 100 through the input portion 110 and may be output to the outside through the output portion 120 of the splitter 100. The input portion 110 may have a tapered structure. The output portion 120 may have a tapered structure. For example, a width of each input channel 110a in the Y-axis direction may increase toward the waveguide 130 in an X-axis direction, and a width of each output channel 120a in the Y-axis direction may increase toward the waveguide 130 in a negative X-axis direction. The input portion 110 and the output portion 120 may each be connected to an external waveguide by the tapered structure.

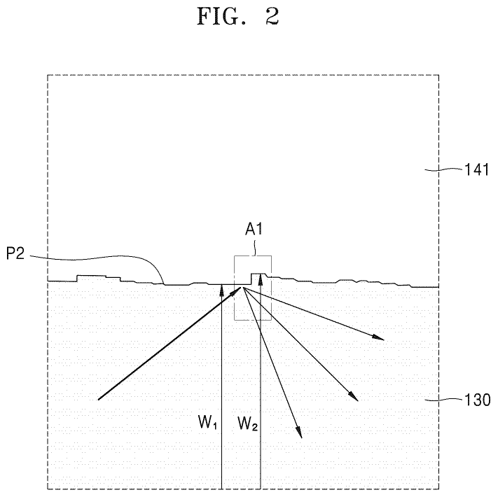

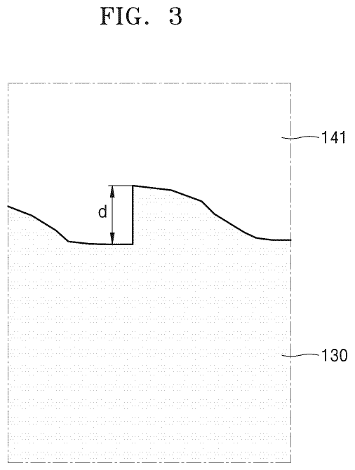

The waveguide 130 may include a plurality of outer lines P1 and P2. The outer lines may include a first outer line P1 and a second outer line P2. The first outer line P1 and the second outer line P2 may each have a diffraction grating structure. The diffraction grating structure is described below with reference to FIGS. 2 and 3.

The waveguide 130 may have a width W in the Y-axis direction and a length L in the X-axis direction. A relationship between the width W and the length L of the waveguide 130 may be determined by an equation below.

$${L}_{c} ≅ \frac{4}{3} n \frac{{W}^{2}}{λ}$$

Here, L_{c} is a length of the splitter 100, n is an effective refractive index of the splitter 100, W is an effective width of the splitter 100, and A is a wavelength of light.

The splitter 100 of FIG. 1 may include a multi-mode interferometer (MMI).

FIG. 2 is a cross-sectional view illustrating an enlarged portion of the splitter 100 in FIG. 1. For example, FIG. 2 is a cross-sectional view illustrating an enlarged state of a portion A of the splitter 100 in FIG. 1.

Referring to FIG. 2, the second outer line P2 of the waveguide 130 may have a diffractive reflection structure by which light may be diffracted and reflected at various angles. A first width W1 and a second width W2 of the waveguide 130 may be different from each other, and the diffractive reflection structure may refer to a structure in which widths of the waveguide 130 are not constant. By adjusting a shape of the diffractive reflection structure of the second outer line P2, an angle and size of the diffracted and reflected light may be adjusted. The first outer line P1 of the waveguide may also have a diffractive reflection structure by which light may be diffracted and reflected at various angles.

FIG. 3 is a cross-sectional view illustrating an enlarged portion of the splitter 100 in FIG. 2. FIG. 3 is a cross-sectional view illustrating an enlarged state of a portion A1 in FIG. 2.

Referring to FIG. 3, in at least some regions of the second outer line P2 of the waveguide 130, widths of the immediately adjacent portions may be changed discontinuously. Discontinuously changing in width indicates a rapid or step-like change in width, and a difference between adjacent portions may be defined as a deviation d. For example, in the second outer line P2 of the waveguide 130, there may be a certain deviation d between widths of the immediately adjacent portions. For example, in FIG. 3, a width of the waveguide 130 may change rapidly by the deviation d between two adjacent portions. The deviation d between widths of adjacent portions may be less than a wavelength of the input light in a vacuum.

The splitter 100 according to one or more embodiments may adjust the amount of light coupled to each channel according to a wavelength by adjusting a shape of a diffractive reflection structure.

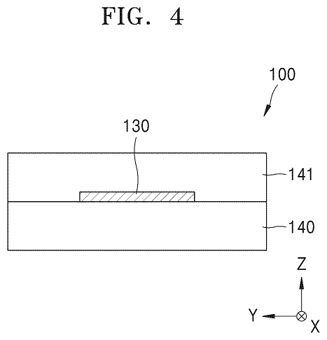

FIG. 4 is a view illustrating a splitter according to one or more embodiments. FIG. 4 is a cross-sectional view illustrating an yz plane of the splitter.

Referring to FIG. 4, a splitter 100 may further include an upper clad 141 provided on a waveguide 130, and a lower clad 140 provided below the waveguide 130.

The upper clad 141 may include a material having a relatively low refractive index. The upper clad 141 may include a material having a refractive index lower than a refractive index of the waveguide 130. The upper clad 141 may include, for example, silicon oxide.

The lower clad 140 may include a material having a relatively low refractive index. The lower clad 140 may include a material having a refractive index lower than the refractive index of the waveguide 130. The lower clad 140 may include, for example, silicon oxide. The material of the upper clad 141 may be identical to or different from the material of the lower clad 140.

The waveguide 130 may include a material having a relatively high refractive index. The waveguide 130 may include a material having a refractive index greater than the upper clad 141. The waveguide 130 may include a material having a refractive index greater than the lower clad 140. The light is focused on the waveguide 130 made of a material having a greater refractive index and is guided. The waveguide 130 may include, for example, silicon or silicon nitride.

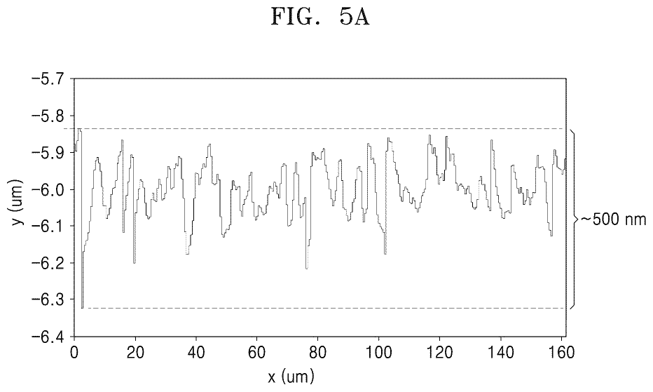

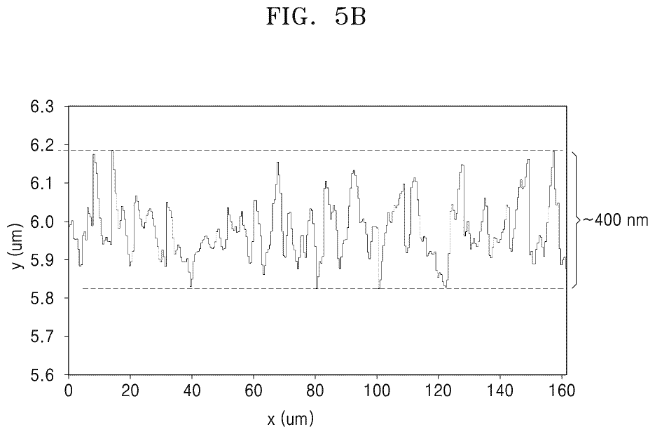

FIGS. 5A and 5B are views illustrating outer lines of a splitter according to one or more embodiments. FIG. 5A is a view illustrating a first outer line (P1 of FIG. 1) of a waveguide (130 of FIG. 1), and FIG. 5B is a view illustrating a second outer line (P2 of FIG. 1) of the waveguide (130 of FIG. 1).

Referring to FIG. 5A, the first outer line (P1 of FIG. 1) of the waveguide (130 of FIG. 1) may have a diffractive reflection structure by which light may be diffracted and reflected at various angles. A deviation between widths of the waveguide (130 of FIG. 1) in the −y direction may be less than or equal to 500 nm.

Referring to FIG. 5B, the second outer line (P2 of FIG. 1) of the waveguide (130 of FIG. 1) may include a diffractive reflection structure by which light may be diffracted and reflected at various angles. A deviation between widths of the waveguide (130 of FIG. 1) n the +y direction may be less than and equal to 400 nm.

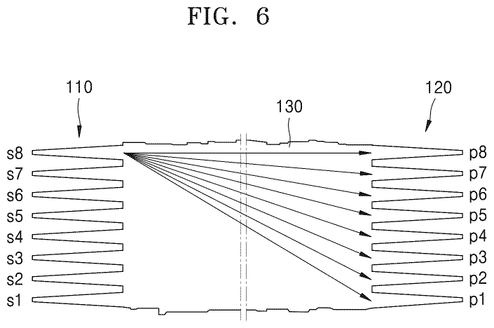

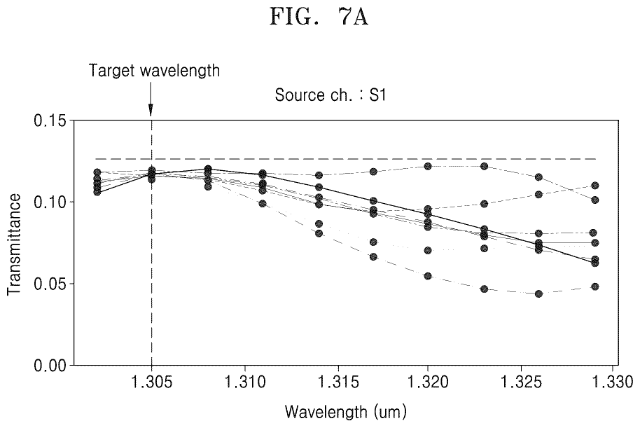

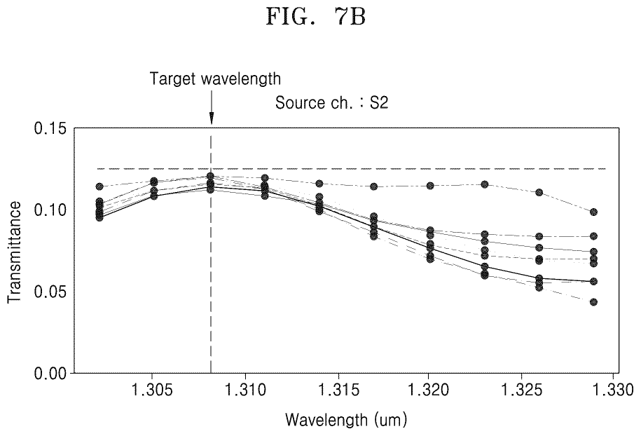

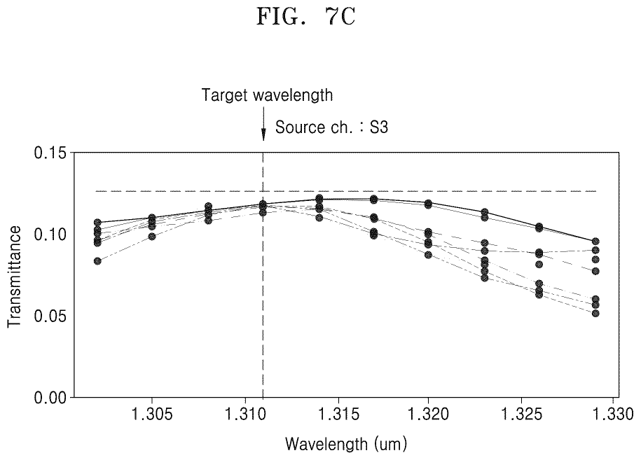

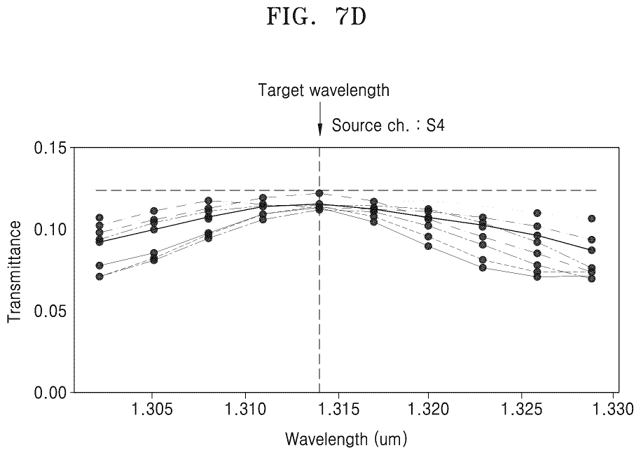

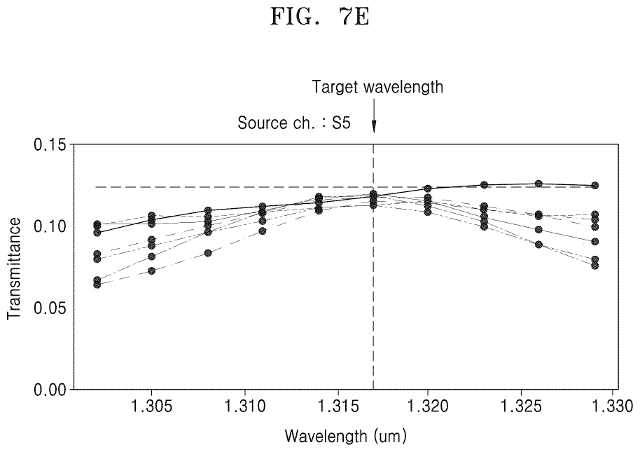

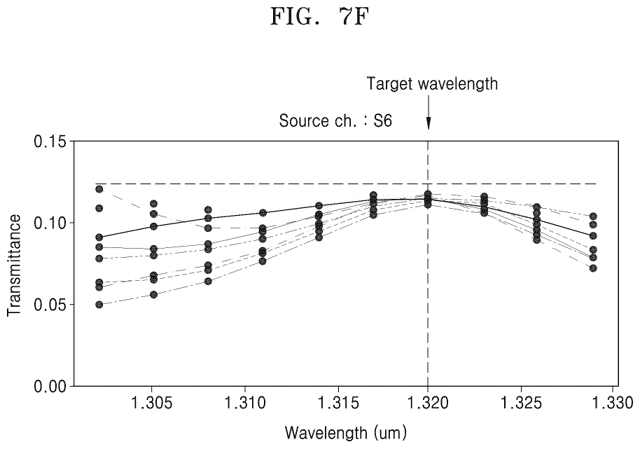

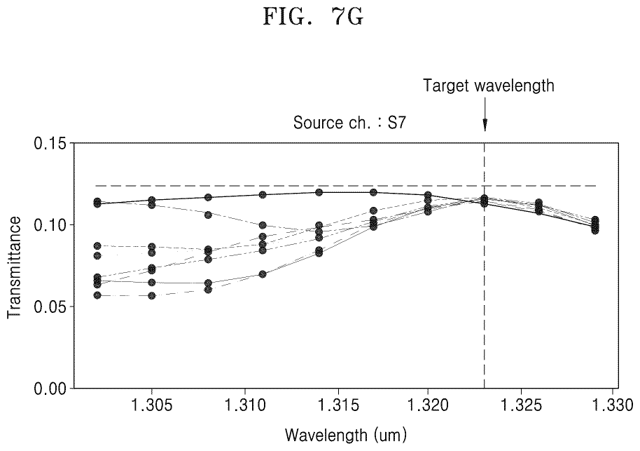

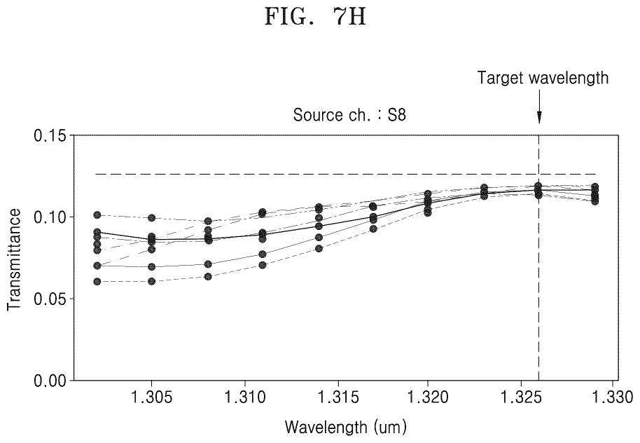

FIG. 6 is a view illustrating inputs and outputs of wavelengths for each channel of a splitter according to one or more embodiments, and FIGS. 7A to 7H are graphs illustrating the inputs and outputs of the wavelengths for each channel of the splitter according to one or more embodiments.

Referring to FIG. 6, the input portion 110 includes a plurality of input channels s1, s2, s3, s4, s5, s6, s7, and s8, and lights having different wavelengths may be respectively incident on the input channels s1 to s8. For example, light may be distributed from the input channel s8 to a plurality of output channels p1, p2, p3, p4, p5, p6, p7, and p8 of the output portion 120. For example, light may be more evenly distributed by 12.5% from the input channel 8 s8 to the plurality of output channels p1 to p8 of the output portion 120.

FIG. 7A is a graphs illustrating a transmission spectrum of light that is input to respective output channels p1 to p8 when the light is incident on the input channel s1.

Referring to FIG. 7A, it may be seen that, when light having a wavelength of 1.305 μm is incident on the input channel s1, each of the plurality of output channels p1 to p8 transmits light therethrough by about 12.5% of the light at a wavelength of 1.305 μm.

FIG. 7B is a graph illustrating a transmission spectrum of light that is input to each of the plurality of output channels p1 to p8 when the light is incident on the input channel s2.

Referring to FIG. 7B, when light having a wavelength of 1.308 μm is incident on the input channel s2, each of the plurality of output channels p1 to p8 transmits light therethrough by about 12.5% of the light at a wavelength of 1.308 μm.

FIG. 7C is a graph illustrating a transmission spectrum of light that is input to the plurality of output channels p1 to p8 when the light is incident on the input channel 3 s3.

Referring to FIG. 7C, when light having a wavelength of 1.311 μm is incident on the input channel s3, each of the plurality of output channels p1 to p8 transmits the light therethrough by about 12.5% of the light at a wavelength of 1.311 um.

FIG. 7D is a graph illustrating a transmission spectrum of light that is input to plurality of output channels p1 to p8 when the light is incident on the input channel s4.

Referring to FIG. 7D, when light having a wavelength of 1.314 μm is incident on the input channel s4, each of the plurality of output channels p1 to p8 transmits the light therethrough by about 12.5% of the light at a wavelength of 1.314 um.

FIG. 7E is a graph illustrating a transmission spectrum of light that is input to each of the plurality of output channels p1 to p8 when the light is incident on the input channel s5.

Referring to FIG. 7E, when light having a wavelength of 1.317 μm is incident on the input channel s5, each of the plurality of output channels p1 to p8 transmits the light therethrough by about 12.5% of the light at a wavelength of 1.317 um.

FIG. 7F is a graph illustrating a transmission spectrum of light that is input to each of the plurality of output channels p1 to p8 when the light is incident on the input channel 6 s6.

Referring to FIG. 7F, when light having a wavelength of 1.320 μm is incident on the input channel s6, each of the plurality of output channels p1 to p8 transmits the light therethrough by about 12.5% of light at a wavelength of 1.320 μm.

FIG. 7G is a graph illustrating a transmission spectrum of light that is input to each of the plurality of output channels p1 to p8 when the light is incident on the input channel s7.

Referring to FIG. 7G, when light having a wavelength of 1.323 μm is incident on the input channel s7, each of the plurality of output channels p1 to p8 transmits the light therethrough by about 12.5% of the light at a wavelength of 1.323 um.

FIG. 7H is a diagram illustrating a transmission spectrum of light that is input to each of the plurality of output channels p1 to p8 when the light is incident on the input channel s8.

Referring to FIG. 7H, when light having a wavelength of 1.326 μm is incident on the input channel s8, each of the plurality of output channels p1 to p8 transmits the light therethrough by about 12.5% of the light at a wavelength of 1.326 μm.

The splitter according to one or more embodiments may more evenly distribute light having a desired wavelength to the plurality of output channels by having a diffractive reflection structure.

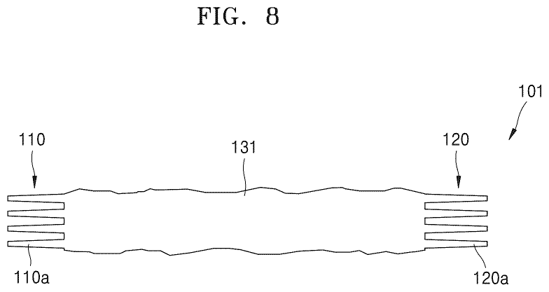

FIG. 8 is a view illustrating a splitter according to one or more embodiments.

Referring to FIG. 8, a splitter 101 may include an input portion 110, an output portion 120, and a waveguide 131 connecting the input portion 110 to the output portion 120.

The waveguide 131 of the splitter 101 may continuously change in widths, in the Y-axis direction, of adjacent portions of the splitter 101 in the X-direction. The splitter 101 may be identical to the splitter 100 of FIG. 1, except that widths of adjacent portions of the waveguide 131 may be continuously changed. In describing FIG. 8, redundant descriptions made with reference to FIG. 1 are omitted.

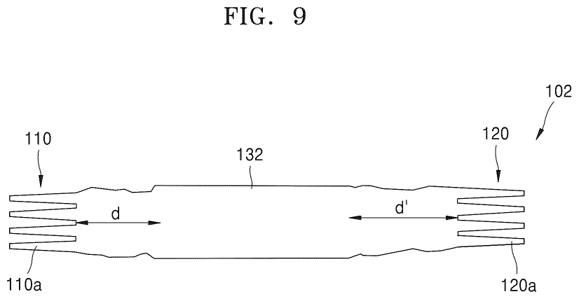

FIG. 9 is a view illustrating a splitter according to one or more other embodiments.

Referring to FIG. 9, a splitter 102 may include an input portion 110, an output portion 120, and a waveguide 132 connecting the input portion 110 to the output portion 120.

The waveguide 132 of the splitter 102 may have a constant width in the Y-axis direction in some regions. For example, in the waveguide 132, a width of a region, which is adjacent to the input portion 110 by a distance d in the X-axis direction, may change discontinuously similarly to the splitter 100 of FIG. 1. Similarly, in the waveguide 132, a width of a region, which is adjacent to the output portion 120 by a distance d′ in the X-axis direction, may change discontinuously similarly to the splitter 100 of FIG. 1. The splitter 102 according to one or more embodiments may have at least one of a distance d and a distance d′. The splitter 102 may be identical to the splitter 100 of FIG. 1, except that the width of the waveguide 132 is constant in some regions. In describing FIG. 9, redundant descriptions made with reference to FIG. 1 are omitted.

FIG. 10 is a view illustrating a splitter according to one or more other embodiments.

Referring to FIG. 10, a splitter 103 may include an input portion 111, an output portion 120, and a waveguide 130 connecting the input portion 111 to the output portion 120.

The input portion 111 may include a plurality of input channels 111a, and the output portion 120 may include a plurality of output channels 120a. The number of the plurality of input channels 111a may be different from the number of the plurality of output channels 120a.

The splitter 103 may be identical to one of the splitter 100 of FIG. 1, the splitter 101 of FIG. 8, and the splitter 102 of FIG. 9, except that the number of the plurality of input channels 111a are different from the number of the plurality of output channels 120a. In describing FIG. 10, redundant descriptions made with reference to FIG. 1 are omitted.

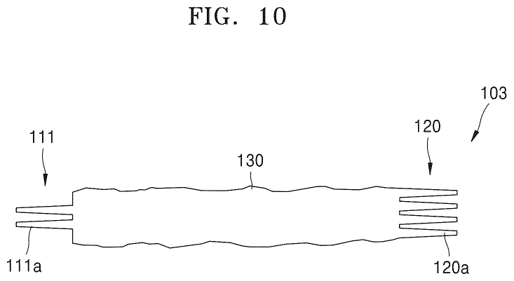

FIG. 11 is a view illustrating a splitter according to one or more other embodiments.

Referring to FIG. 11, a splitter 104 may include an input portion 112, an output portion 120, and a waveguide 130 connecting the input portion 111 to the output portion 120.

The input portion 112 may include one input channel 112a, and the output portion 120 may include a plurality of output channels 120a.

The splitter 104 may be identical to one of the splitter 100 of FIG. 1, the splitter 101 of FIG. 8, and the splitter 102 of FIG. 9, except that the input portion 112 includes the one input channel 112a. In describing FIG. 11, redundant descriptions made with reference to FIG. 1 are omitted.

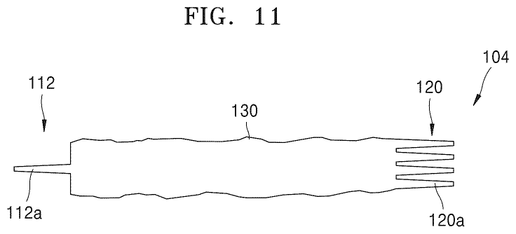

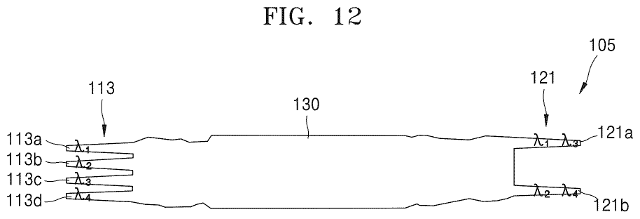

FIG. 12 is a view illustrating a splitter according to one or more other embodiments.

Referring to FIG. 12, a splitter 105 may include an input portion 113, an output portion 121, and a waveguide 130 connecting the input portion 113 to the output portion 121.

The input portion 113 may include a plurality of input channels 113a, 113b, 113c, and 113d, and the output portion 121 may include a plurality of output channels 121a and 121b. Wavelengths of light incident on the plurality of input channels 113a, 113b, 113c, and 113d may be different from each other. Lights having different wavelengths may be respectively incident on the plurality of input channels 113a, 113b, 113c, and 113d. However, embodiments are not limited thereto, and the wavelengths of light incident on the plurality of input channels 113a, 113b, 113c, and 113d may be equal to each other.

Wavelengths of light coupled to each other in the plurality of output channels 121a and 121b may be different from each other or may be equal to each other. The splitter 105 may have different coupling efficiencies for each of the plurality of output channels 121a and 121b or may have the same coupling efficiency. Magnitudes of light coupled to each other in the plurality of output channels 121a and 121b may be different from each other or may be equal to each other.

The splitter 105 may be identical to the splitter 100 of FIG. 1, except for the points described above. In describing FIG. 12, redundant descriptions made with reference to FIG. 1 are omitted.

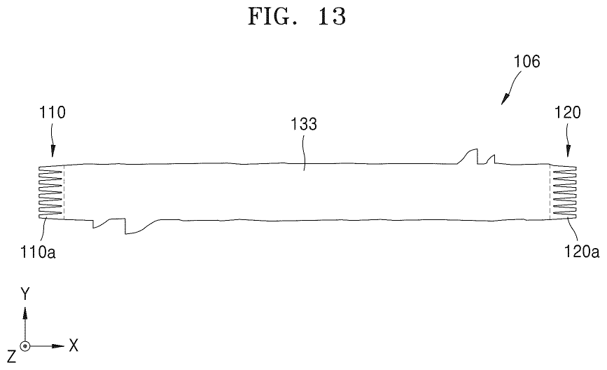

FIG. 13 is a view illustrating a splitter according to one or more other embodiments.

Referring to FIG. 13, a splitter 106 may include an input portion 110, an output portion 120, and a waveguide 133 connecting the input portion 110 to the output portion 120.

In the waveguide 133, a slope of a discontinuity point on a side of the input portion 110 may be different from a slope of a discontinuity point on a side of the output portion 120. For example, the slope of the discontinuity point on a side of the input portion 110 may be relatively steep, and the slope of the discontinuity point on a side of the output portion 120 may be relatively gentle. However, embodiments are not limited thereto, and the slope of the discontinuity point on a side of the input portion 110 may be relatively gentle, and the slope of the discontinuity point on a side of the output portion 120 may be relatively steep.

The splitter 106 may be identical to the splitter 100 of FIG. 1, except for the points described above. In describing FIG. 13, redundant descriptions made with reference to FIG. 1 are omitted.

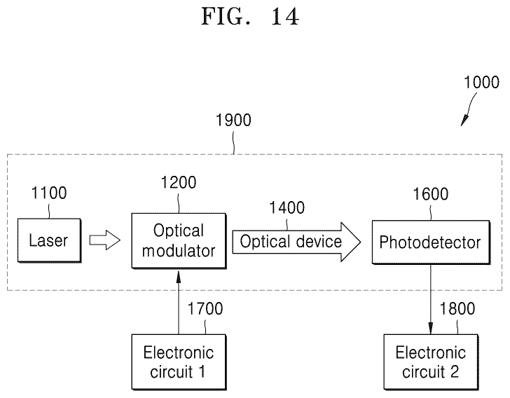

FIG. 14 is a block diagram conceptually illustrating a configuration of a photonic integrated circuit according to one or more embodiments.

Referring to FIG. 14, a photonic integrated circuit 1000 may include a light source 1100, an optical device 1400 that transmits the light from the light source 1100, and a photodetector 1600 that converts the light transmitted from the optical device 1400 into an electrical signal. The optical device 1400 may include a splitter, a ring resonator, a grating coupler, and so on, in addition to a single waveguide, The optical device 1400 may include one of the splitters 100, 101, 102, 103, 104, and 105 respectively illustrated in FIG. 1 and FIGS. 8 to 12.

The photonic integrated circuit 1000 may further include an optical modulator 1200 disposed on the optical device 1400, a first electronic circuit 1700 that applies a modulation signal to the optical modulator 1200, and a second electronic circuit 1800 to which an electric signal converted by the photodetector 1600 is transmitted.

The light source 1100, the optical modulator 1200, the optical device 1400, and the photodetector 1600 may be arranged on a substrate 1900. The substrate 1900 may be a silicon substrate, and the photodetector 1600 may also be a photodiode using a silicon semiconductor.

According to one or more embodiments, there is provided a splitter may include an input portion, an output portion, and a waveguide connecting the input portion to the output portion, wherein widths of adjacent portions in at least some regions of the waveguide change discontinuously, and a deviation between the widths of the adjacent portions may be less than a wavelength of input light in a vacuum.

The input portion may include a plurality of input channels.

Wavelengths of light respectively incident on the plurality of input channels may be different from each other.

The output portion may include a plurality of output channels.

Wavelengths of light coupled to each other in each of the plurality of output channels may be different from each other.

Magnitudes of the light coupled to each other in each of the plurality of output channels may be different from each other.

The input portion may include one input channel, and the output portion may include a plurality of output channels.

The input portion may include a plurality of input channels, the output portion may include a plurality of output channels, and a number of the plurality of input channels may be different from a number of the plurality of output channels.

The input portion may include a plurality of input channels, the output portion may include a plurality of output channels, and the number of the plurality of input channels may be equal to the number of the plurality of output channels.

The input portion may have a tapered structure.

The output portion may have a tapered structure.

The splitter may further include an upper clad provided on an upper portion of the waveguide, and a lower clad provided on a lower portion of the waveguide.

The upper clad may include a material having a refractive index lower than a refractive index of the waveguide.

The upper clad may include silicon oxide.

The lower clad may include silicon oxide.

The waveguide may include one of silicon and silicon nitride.

The waveguide may have a constant width in at least some regions.

According to one or more embodiments, there is provided a photonic integrated circuit may include a light source, a splitter configured to transmit light from the light source, and a photodetector configured to convert the light transmitted from the splitter into electrical signals, wherein the splitter may include an input portion, an output portion, and a waveguide connecting the input portion to the output portion and including an outer line, widths of adjacent portions in at least some regions of the waveguide change discontinuously, and a deviation between the widths of the adjacent portions may be less than a wavelength of input light in a vacuum.

The input portion may include a plurality of input channels, and wavelengths of light incident on the plurality of input channels may be different from each other.

The output portion may include a plurality of output channels, and wavelengths of light coupled to each other in each of the plurality of output channels may be different from each other.

According to one or more embodiments, a splitter that may adjust the amount of light coupled to each channel depending on wavelengths by adjusting a shape of a diffractive reflection structure, and a photonic integrated circuit including the splitter may be provided. Although a splitter and a photonic integrated circuit including the splitter are described with reference to the embodiments illustrated in the drawings, the embodiments are merely examples, and those skilled in the art will understand that various modifications and equivalent other embodiments may be derived therefrom. Therefore, the disclosed embodiments should be considered from an illustrative perspective rather than a restrictive perspective. The scope of rights is indicated in the claims, not in the foregoing descriptions, and all differences within the scope equivalent thereto should be interpreted as being included in the scope of the rights.

According to one or more embodiments, a splitter that may more precisely adjust the distribution of light to output channels, and a photonic integrated circuit including the splitter are provided.

While embodiments have been described with reference to the figures, it will be understood by those of ordinary skill in the art that various changes in form and details may be made therein without departing from the spirit and scope as defined by the following claims and their equivalents.

What is claimed is:

1. A splitter comprising:
an input portion;
an output portion; and
a waveguide connected between the input portion and the output portion,
wherein widths of adjacent portions in at least some regions of the waveguide change discontinuously, and
wherein a deviation between the widths of the adjacent portions is less than a wavelength of input light in a vacuum.

2. The splitter of claim 1, wherein the input portion comprises a plurality of input channels.

3. The splitter of claim 2, wherein wavelengths of light respectively incident on the plurality of input channels are different from each other.

4. The splitter of claim 1, wherein the output portion comprises a plurality of output channels.

5. The splitter of claim 4, wherein wavelengths of light coupled to each other in each of the plurality of output channels are different from each other.

6. The splitter of claim 4, wherein magnitudes of the light coupled to each other in each of the plurality of output channels are different from each other.

7. The splitter of claim 1, wherein the input portion comprises one input channel, and
wherein the output portion comprises a plurality of output channels.

8. The splitter of claim 1, wherein the input portion comprises a plurality of input channels,
wherein the output portion comprises a plurality of output channels, and
wherein a number of the plurality of input channels is different from a number of the plurality of output channels.

9. The splitter of claim 1, wherein the input portion comprises a plurality of input channels,
wherein the output portion comprises a plurality of output channels, and
wherein a number of the plurality of input channels is equal to a number of the plurality of output channels.

10. The splitter of claim 1, wherein the input portion has a tapered structure.

11. The splitter of claim 1, wherein the output portion has a tapered structure.

12. The splitter of claim 1, further comprising:
an upper clad on a first portion of the waveguide; and
a lower clad on a second portion of the waveguide opposite to the first portion of the waveguide.

13. The splitter of claim 12, wherein the upper clad comprises a material having a refractive index that is lower than a refractive index of the waveguide.

14. The splitter of claim 12, wherein the upper clad comprises silicon oxide.

15. The splitter of claim 12, wherein the lower clad comprises silicon oxide.

16. The splitter of claim 1, wherein the waveguide comprises one of silicon and silicon nitride.

17. The splitter of claim 1, wherein a width of the waveguide is constant in at least some regions of the waveguide.

18. A photonic integrated circuit comprising:
a light source configured to emit light;
a splitter configured to transmit the light from the light source; and
a photodetector configured to convert the light transmitted from the splitter into electrical signals;
wherein the splitter comprises:
an input portion;
an output portion; and
a waveguide connected between the input portion and the output portion, the waveguide comprising an outer line,
wherein widths of adjacent portions in at least some regions of the waveguide change discontinuously, and
wherein a deviation between the widths of the adjacent portions is less than a wavelength of input light in a vacuum.

19. The photonic integrated circuit of claim 18, wherein the input portion comprises a plurality of input channels, and
wherein wavelengths of light incident on the plurality of input channels are different from each other.

20. The photonic integrated circuit of claim 18, wherein the output portion comprises a plurality of output channels, and
wherein wavelengths of light coupled to each other in each of the plurality of output channels are different from each other.
